(19) United States
(12) Patent Application Publication
(10) Pub. No.: US 2010/0037281 A1
(43) Pub. Date: Feb. 11, 2010

(54) MISSING FRAME GENERATION WITH TIME SHIFTING AND TONAL ADJUSTMENTS

(75) Inventor: James D. Bennett, Hroznetin (CZ)

Correspondence Address: GARLICK HARRISON & MARKISON, P.O. BOX 160727, AUSTIN, TX, 78716-0727, US

(73) Assignee: Broadcom Corporation, Irvine, CA (US)

(21) Appl. No.: 12/277,965

(22) Filed: Nov. 25, 2008

Related U.S. Application Data
(60) Provisional application No. 61/086,395, filed on Aug. 5, 2008.

(51) Int. Cl. H04N 7/173

(52) U.S. Cl. 725/127; 725/131

(57) ABSTRACT

An electronic device communicatively couples to a set top box and includes a missing frame generation module and a time shifting/tone adaptation module. The missing frame generation module restores one or more sequential lost video frames to eliminate unwanted video effects at the recipient devices. The missing frame generation module restores one or more lost video frames by considering preceding and succeeding video frames, retaining those pixels and colors that are similar, and taking an average of those that differ. In case of few sequential lost video frames, the missing frame generation module computes pixel and color magnitudes in their respective pixel and color positions of all of few preceding and succeeding sequential video frames. The missing frame generation module computes incremental magnitudes for each of the few missing sequential video frames in their respective pixel and color positions, to generate difference pixels and colors of the few missing sequential video frames (when they differ in magnitudes). The time shifting/tone adaptation module eliminates unwanted audio effects at recipient device

### BACKGROUND

1. Technical Field

The present invention relates generally to multimedia communication; and, more particularly to video streaming.

2. Related Art

The broadcast of digitized video/audio information (multimedia content) is well known. Limited access communication networks such as cable television systems, satellite television systems, and direct broadcast television systems support delivery of digitized multimedia content via controlled transport medium. In the case of a cable modem system, a dedicated network that includes cable modem plant is carefully controlled by the cable system provider to ensure that the multimedia content is robustly delivered to subscribers' receivers. Likewise, with satellite television systems, dedicated wireless spectrum robustly carries the multi-media content to subscribers' receivers. Further, in direct broadcast television systems such as High Definition (HD) broadcast systems, dedicated wireless spectrum robustly delivers the multi-media content from a transmitting tower to receiving devices. Robust delivery, resulting in timely receipt of the multimedia content by a receiving device is critical for the quality of delivered video and audio.

Some of these limited access communication networks now support on-demand programming in which multimedia content is directed to one, or a relatively few number of receiving devices. The number of on-demand programs that can be serviced by each of these types of systems depends upon, among other things, the availability of data throughput between a multimedia source device and the one or more receiving devices. Generally, this on-demand programming is initiated by one or more subscribers and serviced only upon initiation.

Publicly accessible communication networks, e.g., Local Area Networks (LANs), Wireless Local Area Networks (WLANs), Wide Area Networks (WANs), Wireless Wide Area Networks (WWANs), and cellular telephone networks, have evolved to the point where they now are capable of providing data rates sufficient to service streamed multimedia content. The format of the streamed multimedia content is similar/same as that that is serviced by the limited access networks, e.g., cable networks, satellite networks. However, each of these communication networks is shared by many users that compete for available data throughput. Resultantly, streamed multimedia content is typically not given preferential treatment by these networks.

Generally, streamed multimedia content is formed/created by a first electronic device, e.g., web server, personal computer, user equipment, etc., transmitted across one or more communication networks, and received and processed by a second electronic device, e.g., personal computer, laptop computer, cellular telephone, WLAN device, or WWAN device. In creating the multimedia content, the first electronic device obtains/retrieves multimedia content from a video camera or from a storage device, for example, and encodes the multimedia content to create encoded audio and video frames according to a standard format, e.g., Quicktime, (motion picture expert group) MPEG-2, MPEG-4, or H.264, for example. The encoded audio and video frames are placed into data packets that are sequentially transmitted from the first electronic device onto a servicing communication network, the data packets addressed to one or more second electronic device(s). The sequentially transmitted sequence of encoded audio/video frames may be referred to as a video stream or an audio/video stream. One or more communication networks carry the data packets to the second electronic device. The second electronic device receives the data packets, reorders the data packets if required, and extracts the encoded audio and video frames from the data packets. A decoder of the second electronic device decodes the encoded audio and/or video frames to produce audio and video data. The second electronic device then stores the video/audio data and/or presents the video/audio data to a user via a user interface.

Each video frame is carried by one or more data packets. When data packets are lost or damaged in transit, the decoding component of the second electronic device produces output with missing information, e.g., blank portions in a video image for a period of time that is noticeable to a user. These and other limitations and deficiencies associated with the related art may be more fully appreciated by those skilled in the art after comparing such related art with various aspects of the present invention as set forth herein with reference to the figures.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

FIG. 1 is a schematic block diagram illustrating a digital program source and a frame adapter that communicatively coupled to a plurality of recipient devices via the Internet and a set top box, the set top box having a missing frame generation module and time shifting/tone adaptation module constructed and operating according to one or more embodiments of the present invention;

FIG. 2 is a schematic block diagram illustrating components of the set top box of FIG. 1, including the missing frame generation module and time shifting/tone adaptation module constructed and operating in accordance with one or more embodiments of the present invention;

FIG. 3 is a schematic block diagram illustrating components of a missing frame generation module constructed and operating according to one or more embodiments of the present invention;

FIG. 4 is a schematic block diagram illustrating components of the time shifting/tone adaptation circuitry constructed in accordance with one or more embodiments of the present invention;

FIG. 5 is a flow diagram illustrating operation of a set top box containing a missing frame generation module and time shifting/tone adaptation module constructed and operating according to one or more embodiments of the present invention;

FIG. 6 is a flow diagram illustrating operation of a missing frame generation module during restoration of a lost video frame; and

FIG. 7 is a flow diagram illustrating operation of a missing frame generation module of during restoration of sequential lost video frames.

### DETAILED DESCRIPTION OF THE DRAWINGS

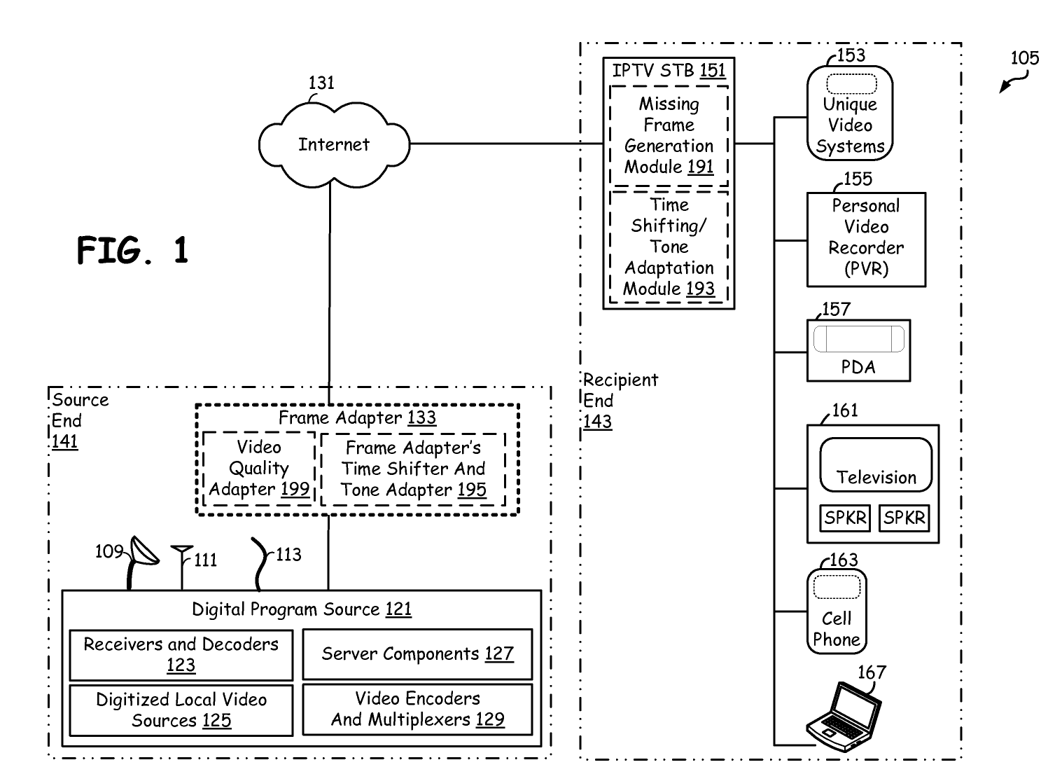

FIG. 1 is a schematic block diagram illustrating a digital program source and a frame adapter that communicatively coupled to a plurality of recipient devices via the Internet and a set top box, the set top box having a missing frame generation module and time shifting/tone adaptation module constructed and operating according to one or more embodiments of the present invention. The structure 105 of FIG. 1 includes an Internet based digital program source 121 communicatively coupled at a front end with a frame adapter 133 that communicatively couples to a plurality of recipient devices 153, 155, 157, 161, 163 and 167 via the Internet 131 and a set top box 151 that contains a missing frame generation module 191 and time shifting/tone adaptation module 193. The missing frame generation module 191 restores missing video frames to eliminate unwanted video artifacts at the recipient end 143. In specific, the missing frame generation module 191 receives de-multiplexed, de-packetized, decoded and decompressed digital video program signals containing a plurality of video frames from the set top box 151 and buffers video frame, e.g., at least 1 second's worth of video quality adapted video frames or video frames belonging to one frame set. The video frames are continuously buffered and released to the set top box 151 for further processing when no missing video frames are found.

However, if the missing frame generation module 191 identifies one or more missing or corrupted video frame among the buffered video frames it identifies at least one preceding and at least one succeeding video frames of a video frame stream relating to the missing video frame. Once these preceding and succeeding video frames are identified, the missing frame generation module 191 computes pixel and color magnitudes, in their respective pixel and color positions, of both the preceding and succeeding video frames and stores them temporarily. Then, the missing frame generation module 191 identifies similarities in the magnitudes that fall within a threshold, in their respective pixel and color positions, between the preceding and succeeding video frames and generates similar pixels and colors for the missing video frame. The differences in pixels and colors of the missing video frame is generated by computing average magnitudes for the missing video frame, in their respective pixel and color positions, when the magnitudes fall beyond the threshold, from the preceding and succeeding video frame. Finally, the missing frame generation module 191 generates the entire missing video frame by combining the similar pixels and colors and difference pixels and colors, in their respective pixel and color positions. Then, the video frames are released back to the set top box 151, or the time shifting and tone adaptation module 193, for further processing, if any. Note that in some operations an initial decoding of incoming video frames is performed to identify whether frames are missing.

In case of few missing sequential video frames, the missing frame generation module 191 identifies any such ‘few missing sequential video frames’ among the buffered video frames. Then, the missing frame generation module 191 identifies at least one preceding and at least one succeeding sequential video frames, of the few missing sequential video frames and computes pixel and color magnitudes, in their respective pixel and color positions, of each of the few preceding and succeeding sequential video frames. Then, the missing frame generation module 191 identifies similarities in the magnitudes that fall within a threshold, in their respective pixel and color positions, between the few preceding and succeeding sequential video frames, and generates similar pixels and colors of the few missing sequential video frames. These similar pixels and colors in their respective positions are common for all of the few missing sequential video frames.

Then, the missing frame generation module 191 computes incremental magnitudes for each of the few missing sequential video frames, in their respective pixel and color positions, when the magnitudes fall beyond the threshold, from the few preceding and succeeding sequential video frames and thus generates difference pixels and colors of the few missing sequential video frames. In other words, if there is a pattern between each of the preceding and succeeding sequential video frames, then such pattern is recognized and in respective pixel and color position and incremental magnitudes of pixel and colors are assigned to each of the few missing sequential video frames. Once, similar and difference pixels and colors are generated for each of the few missing sequential video frames, the missing frame generation module 191 generates each of the few missing sequential video frames by combining the similar pixels and colors of the few missing sequential video frames and difference pixels and colors of the few missing sequential video frames, in their respective missing video frames, and pixel and color positions. Then, the video frames are released back to the set top box 151, or the time shifting and tone adaptation module 193 along with the restored sequential video frames in their positions among the frame set for further processing, if any.

When, there are abrupt changes either between the few preceding sequential video frames alone or between the few succeeding sequential video frames alone, then only one set, either the few succeeding or preceding sequential video frames alone are used to generate the few missing sequential video frames. Such occurrences may happen if there are changes in the scenery or background, such as jumping from one scene to another, or one background location to another.

For example, if there is sudden scenery change in the few preceding sequential video frames (that is, when there are differences between any two video frames that is beyond an average difference threshold, in the few preceding sequential video frames), then the missing frame generation module 191 generates all of the pixels and colors of the few missing sequential video frames, by taking incremental magnitudes from the few succeeding sequential video frames alone. This is done by computing incremental magnitudes for each of the few missing sequential video frames, in their respective pixel and color positions, from the few succeeding sequential video frames and generating difference pixels and colors of the few missing sequential video frames. In this case, there are no similar pixels and colors generated, and all of the pixels and colors are generated by considering difference pixels and colors alone.

Similarly, if there is abrupt change in the few succeeding sequential video frames (that is, when there are differences between any two video frames that is beyond an average difference threshold, in the few succeeding sequential video frames), then the missing frame generation module 191 generates all of the pixels and colors of the few missing sequential video frames, by taking incremental magnitudes from the few preceding sequential video frames alone. This is done by computing incremental magnitudes for each of the few missing sequential video frames, in their respective pixel and color positions, from the few preceding sequential video frames and generating difference pixels and colors of the few missing sequential video frames. In this case, there are no similar pixels and colors generated. Again, the video frames are released back to the set top box 151, or the time shifting and tone adaptation module 193 along with the restored sequential video frames in their positions among the frame set for further processing, if any.

The missing frame generation module 191 identifies the missing video frame or few missing sequential video frames by identifying number of video frames in a frame set and then identifying one or more sequential video frames that are not generated during decoding and decompression. Alternatively, the missing frame generation module 191 may identify the missing video frame or few missing sequential video frames by identifying number of frames in a second during video quality adaptation and then identifying one or more sequential video frames that are not generated during decoding and decompression. In addition, the threshold mentioned above is determined by an average user's inability to distinguish the differences between any two video frames that fall within the threshold, in all of respective color and pixel positions.

The illustration 105 depicts typical recipient devices at the recipient end 143 such as unique video systems 153, personal video recorder 155, PDA (Personal Digital Assistant) 157, television 161 having a display and speakers (SPKRs), cell phone 163 and personal or laptop computer 167, communicatively coupled to the Internet based digital program source 121 via Internet 131, the set top box 151 and frame adapter 133. At the source end 141, there is a frame adapter 133 at the front end of the Internet based digital program source 121. The illustration 105 also depicts various components of the Internet based digital program source 121 that include receivers and decoders 123, digitized local video sources 125, server components 127 and encoders and multiplexers 129, and communication tools to receive external programs from their source such as a satellite dish 109, an antenna 111 and cable or fiber optic connections 113.

The frame adapter's time shifter/tone adapter 195 receives digital video program signals along with digital audio program signals from the video quality adapter 199 and applies modifications and sound effects on the digital audio program signals to compensate for the adaptive reductions in frame rate (performed by the video quality adapter 199). The time shifting and tone adaptation module 193, in turn, receives digital video program signals along with digital audio program signals from the set top box 151 or the missing frame generation module 191 and applies modifications and sound effects on the digital audio program signals to compensate for missing video frames. That is, the modules 195 and 193 resynchronize, and gradually shift frequency of digital audio program signals to compensate for any dropped, lost or missing video frames (in case of missing video frames, it is missing video frames that cannot be restored). Though, the frame adapter's time shifter/tone adapter 195 and time shifting and tone adaptation module 193 work by interacting with one another, as far as the adaptive reductions in frame rates are concerned, the time shifting and tone adaptation functionalities may not be repeated at both modules 195 and 193.

The time shifting and tone adaptation functionalities of module 193 involves elimination of digital audio program signals that correspond to the few missing sequential video frames that cannot be restored. The tone adaptation functionality involves gradual upward frequency shift during a period of few frames, starting at few frames before first video frame (of the few missing sequential video frames that cannot be restored) and ending at the first video frame (of the few missing sequential video frames that cannot be restored), followed by gradual downward frequency shift for a time period starting at last video frame (of the few missing sequential video frames that cannot be restored) and ending at few frames after the last video frame (of the few missing sequential video frames that cannot be restored).

For example, a television 161 may be connected to the IPTV STB 151, to receive digital video programs from the Internet based digital program source 121. Any video program signals received by the television 161 with missing video frames cause unwanted effects in the reproduction at screen and speakers. The frame adapter 133 determines the video quality adaptation parameters along with compression technology and corresponding parameters by receiving the television 161 video and audio configurations, via the IPTV STB 151. Then, the video quality adapter 199 dynamically varies the frame rate, color and pixel resolutions on the basis of the frame set backdrop, audio and video configurations of the television 161. During the reception, the IPTV STB 151 processes the IPTV packets by de-multiplexing, decoding to extract digital audio, and video and data program signals.

Then, the missing frame generation module 191 of the IPTV STB 151 begins to buffer video frames sequentially, and in the meanwhile keeps searching for any missing video frames in the buffer. If the few missing sequential video frames are identified, then the missing frame generation module 191 identifies few preceding and succeeding sequential video frames from the buffer and computes pixel and color magnitudes, in their respective pixel and color positions. Then, the missing frame generation module 191 identifies similarities in the magnitudes that fall within a threshold (determined on the basis of an average user's inability to distinguish any difference between two video frames with minor differences), in their respective pixel and color positions, between the few preceding and succeeding sequential video frames, and generates similar pixels and colors of the few missing sequential video frames.

Then, the missing frame generation module 191 computes incremental magnitudes for each of the few missing sequential video frames, in their respective pixel and color positions, when the magnitudes fall beyond the threshold, from the few preceding and succeeding sequential video frames and thus generates difference pixels and colors of the few missing sequential video frames. Then, the missing frame generation module 191 generates each of the few missing sequential video frames by combining the similar pixels and colors of the few missing sequential video frames and difference pixels and colors of the few missing sequential video frames, in their respective video frames, and pixel and color positions.

Then, the video frames are released back to the time shifting and tone adaptation module 193 along with the few missing and restored sequential video frames in their position among frame set for further processing. The time shifting and tone adaptation module 193 applies the above mentioned modifications and sound effects on the digital audio program signals. As a result, the digital video program signals received by the television 161 produces no discernable deterioration in video or audio reproductions, even when many frames are dropped, missing or lost.

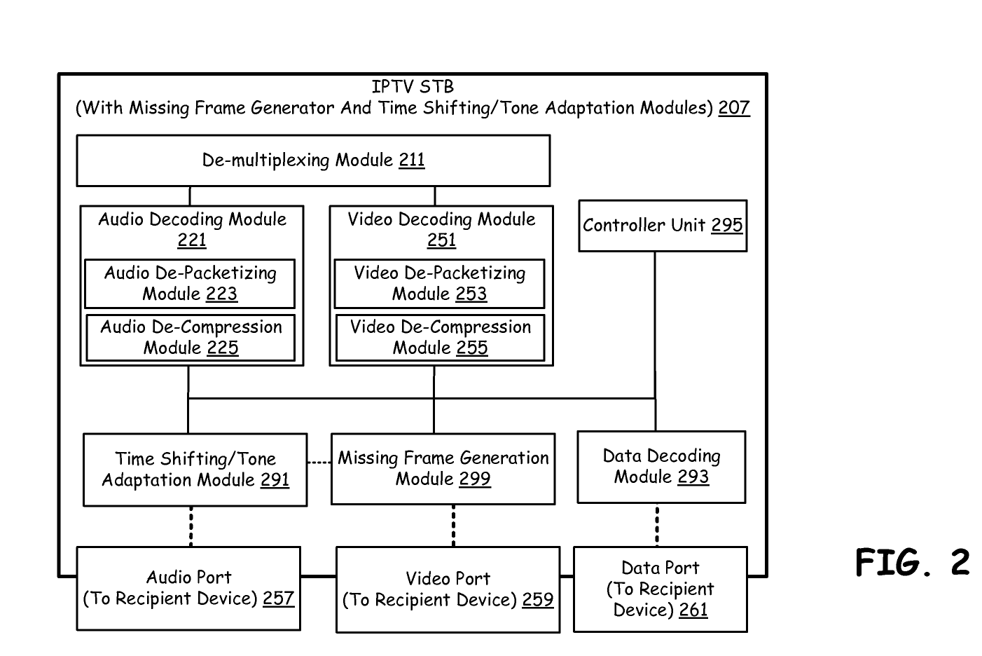

FIG. 2 is a schematic block diagram illustrating components of the set top box of FIG. 1, including the missing frame generation module and time shifting/tone adaptation module constructed and operating in accordance with one or more embodiments of the present invention. The set top box 207 includes the missing frame generation module 299 and time shifting and tone adaptation module 291 constructed in accordance with the embodiments of FIG. 1 of the present invention. The Internet Protocol Tele-Vision Set Top Box (IPTV STB) 207 contains a plurality of modules to de-multiplex, decode, generate one or more missing sequential video frames, time shift, and tone adapt audio signals, and deliver audio, video and data signals to recipient devices. The plurality of modules at the receiving end of the IPTV STB 207 includes a de-multiplexing module 211. The de-multiplexing module 211 separates audio, video and data IP program packets from the incoming IP program signals and delivers them to corresponding audio decoding module 221, video decoding module 251 and data decoding module 293.

The audio decoding module 221 contains audio de-packetizing module 223 and audio decompression module 225. The audio de-packetizing module 223 removes IP protocol information from the audio IP packets, extracts and delivers compressed audio signals (for example, using the MP3 compression format), to the audio decompression module 225. The audio decompression module 225 decompresses the incoming compressed audio signals and extracts the raw audio signal in a standard format.

Similarly, the video decoding module 251 contains video de-packetizing module 253 and video decompression module 255, which in turn remove IP protocol information from the audio IP packets and extract compressed video signals (for example, using MPEG4 compression format), and then decompress to extract the raw video signal in a standard format, respectively. The raw video signal, containing information of many video frames is delivered to the missing frame generation module 299. The missing frame generation module 299 temporarily stores these raw video signals that contain a plurality of sequential video frame information in a buffer memory.

Then, the missing frame generation module 299 identifies one or more missing sequential video frames among the buffered video frames. Then, the missing frame generation module 299 identifies one or more preceding and succeeding sequential video frames, of the one or more missing sequential video frames and computes pixel and color magnitudes, in their respective pixel and color positions, of each of the one or more preceding and succeeding sequential video frames.

Then, the missing frame generation module 299 identifies similarities in the magnitudes that fall within a threshold, in their respective pixel and color positions, between the one or more preceding and succeeding sequential video frames, and generates similar pixels and colors of the one or more missing sequential video frames. These similar pixels and colors in their respective positions are common for all of the one or more missing sequential video frames. Note that, in case of only one missing video frame, the missing frame generation module 299 considers only one preceding and one succeeding sequential video frame, and performs the above mentioned functionality.

Then, the missing frame generation module 299 computes average values (in case of one missing video frame) or incremental magnitudes (in case of few missing sequential video frames), for each of the one or more missing sequential video frames, in their respective pixel and color positions, when the magnitudes fall beyond the threshold, from the one or more preceding and succeeding sequential video frames and thus generates difference pixels and colors of the one or more missing sequential video frames. Again, in case of only one missing video frame, the missing frame generation module 299 considers only one preceding and one succeeding sequential video frame, and performs the above mentioned functionality, using average values of the differences in pixel and color magnitudes.

Once, similar and difference pixels and colors are generated for each of the one or more missing sequential video frames, the missing frame generation module 299 generates each of the one or more missing sequential video frames by combining the similar pixels and colors of the one or more missing sequential video frames and difference pixels and colors of the one or more missing sequential video frames, in their respective missing video frames, and pixel and color positions.

Then, the raw audio signals from the audio decoding module 221 is delivered to a time shifting and tone adaptation module 291, which in turn applies modifications and compensative sound effects on the raw audio signals to compensate for the adaptive reductions in frame rate and missing video frames that cannot be restored. The time shifting involves elimination of digital audio program signals that correspond to dropped frames during the adaptive reductions in frame rate and resynchronization. The tone adaptation functionality involves gradual upward frequency shift during a period of few frames, starting at few frames before first dropped frame and ending at the first dropped frame, followed by gradual downward frequency shift for a time period starting at last dropped frame and ending at few frames after the last dropped frame.

Then, the time shifted and tone adapted audio signal is delivered to an audio port 257, while video signals from the missing frame generation module 299 are delivered to a video port 259 and data signals are delivered to a data port 261. The data decoding module 293 decodes incoming information as is required and delivers the decoded output to data port 261 that communicatively couples one or more serviced recipient devices. The data port 261 is bidirectional to both send to and receive data from one or more recipient devices. This data may be returned to the source end 141 to modify the audio/video sent from the source end based upon recipient device characteristics. In addition, all of the modules of the IPTV STB 207 are controlled and monitored by a controller unit 295.

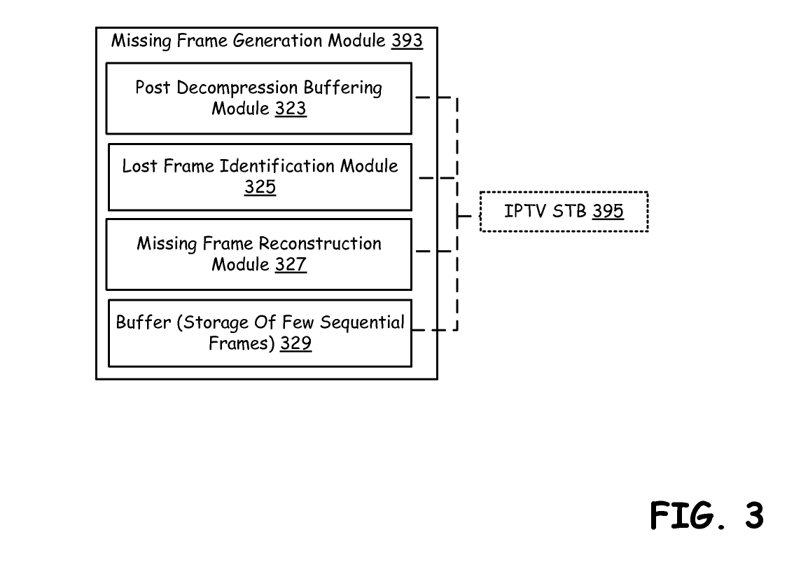

FIG. 3 is a schematic block diagram illustrating components of a missing frame generation module constructed and operating according to one or more embodiments of the present invention. The missing frame generation module 393 contains a plurality of modules to generate one or more missing sequential video frames by considering sequential video frames adjacent to one or more missing sequential video frames. The missing frame generation module 393 generates one or more missing sequential video frames by considering either or both of similar, average of difference and incremental values from the difference of one or more preceding and succeeding sequential video frames to that of the one or more missing sequential video frames.

The plurality of modules includes a post decompression buffering module 323, lost frame identification module 325, missing frame reconstruction module 327, and buffer 329. The raw video signal, containing information of many video frames for every second, is received by the post decompression buffering module 323 and it temporarily stores these raw video signals that contain a plurality of sequential video frame information in the buffer 329. That is, the post decompression buffering module 323 continuously buffers (temporarily stores) these sequential video frames in a queue fashion, in the buffer 329, and then releases back to set top box 395, for further processing, when no missing video frames are found.

The lost frame identification module 325, in turn, continuously searches for any missing video frames in the buffer 329, and when a missing video frame among the buffered video frames is identified, notifies the missing frame reconstruction module 327. Then, the missing frame reconstruction module 327 identifies one preceding and succeeding video frames, of the missing video frame and computes pixel and color magnitudes, in their respective pixel and color positions, of both the preceding and succeeding video frames. Then, the missing frame reconstruction module 327 identifies similarities in the magnitudes that fall within a threshold, in their respective pixel and color positions, between the preceding and succeeding video frames, and generates similar pixels and colors of the missing video frame. Then, the missing frame reconstruction module 327 computes average values for the missing video frame, in their respective pixel and color positions, when the magnitudes fall beyond the threshold, from the preceding and succeeding video frames and thus generates difference pixels and colors of the missing video frame. Once, similar and difference pixels and colors are generated for the missing video frame, the missing frame reconstruction module 327 generates the missing video frame by combining the similar pixels and colors of the missing video frame, and difference pixels and colors of the missing video frame, in their respective pixel and color positions.

In case of more than one (few) missing sequential video frames, the missing frame reconstruction module 327 identifies at least one preceding and at least one succeeding sequential video frames of the few missing sequential video frames and computes pixel and color magnitudes, in their respective pixel and color positions, of each of the few preceding and succeeding sequential video frames. Then, the missing frame reconstruction module 327 identifies similarities in the magnitudes that fall within a threshold, in their respective pixel and color positions, between the few preceding and succeeding sequential video frames, and generates similar pixels and colors of the few missing sequential video frames. These similar pixels and colors in their respective positions are common for all of the few missing sequential video frames.

Then, the missing frame reconstruction module 327 computes incremental magnitudes for each of the few missing sequential video frames, in their respective pixel and color positions, when the magnitudes fall beyond the threshold, from the few preceding and succeeding sequential video frames and thus generates difference pixels and colors of the few missing sequential video frames. Once, similar and difference pixels and colors are generated for each of the few missing sequential video frames, the missing frame reconstruction module 327 generates each of the few missing sequential video frames by combining the similar pixels and colors of the few missing sequential video frames and difference pixels and colors of the few missing sequential video frames, in their respective missing video frames, and pixel and color positions.

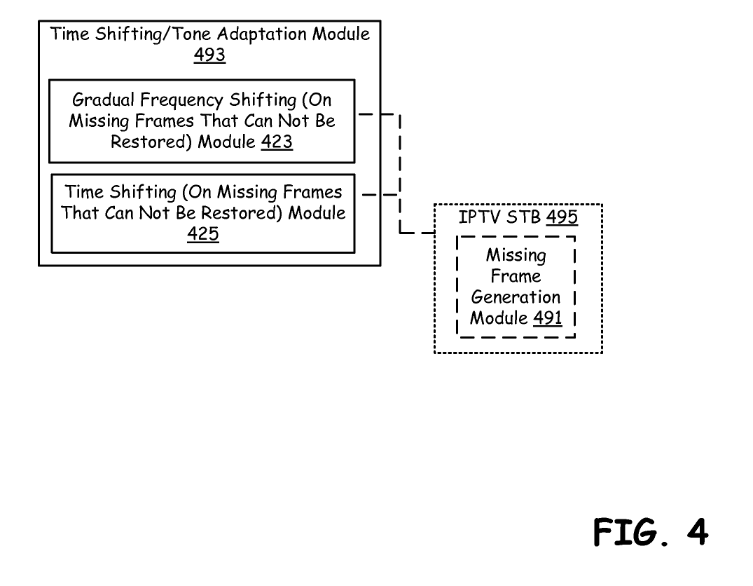

FIG. 4 is a schematic block diagram illustrating components of the time shifting/tone adaptation circuitry constructed in accordance with one or more embodiments of the present invention. The time shifting and tone adaptation circuitry 493 includes modules such as time shifting module 425 and gradual frequency shifting module 423 to perform time shift and tone adaptation of incoming digital audio program signals from set top box 495. These modules also receive digital video program signals from the missing frame generation module 491 along with information about first and last of video frames that are not restored (when too many lost video frames are encountered, the missing frame generation module 491 may not be able to restore those missing video frames, for example) during searching for missing frames and restoration of missing video frames, from the set top box 495.

In effect the time shifting and tone adaptation circuitry 493 eliminates digital audio program signals that correspond to the missing video frames that cannot be restored (i.e., duration of frames in between first and last of the missing video frames that cannot be restored), reassembles remaining digital audio program signals, resynchronizes with the digital video program signals, then gradually shifts in frequency set, first upwards and then downwards during the periods when video frames are missing and cannot be restored.

The time shifting module 425 initially eliminates the digital audio program signals that correspond to the missing video frames that cannot be restored (during the missing video frame restoration) and reassembles the rest of the digital audio program signals. Then, the time shifting module 425 resynchronizes the remaining digital audio program signals with that of digital video program signals.

The gradual frequency shifting module 423, then, identifies the first and last video frames of the missing video frames that cannot be restored and gradually shifts frequency upwards and then downwards, in the interval of few frames, starting at few frames before first of the missing video frames that cannot be restored and ending at few frames after the last of the missing video frames that cannot be restored, in such a way as to not have any discernable unwanted effects in audio reproductions. The gradual upward frequency shift is performed during a period of few frames, starting at few frames before first of the missing video frames that cannot be restored and ending at the first of the missing video frames that cannot be restored. Then, the gradual downward frequency shift is performed for a time period starting at last of the missing video frames that cannot be restored and ending at few frames after the last of the missing video frames that cannot be restored.

The gradual frequency shift itself consists of shifting entire frequency set in upward or downward directions, during the above mentioned periods. Once, these operations on the digital audio program signals are performed, the gradual frequency shifting module 423 delivers these digital video and audio program signals back to the set top box 495.

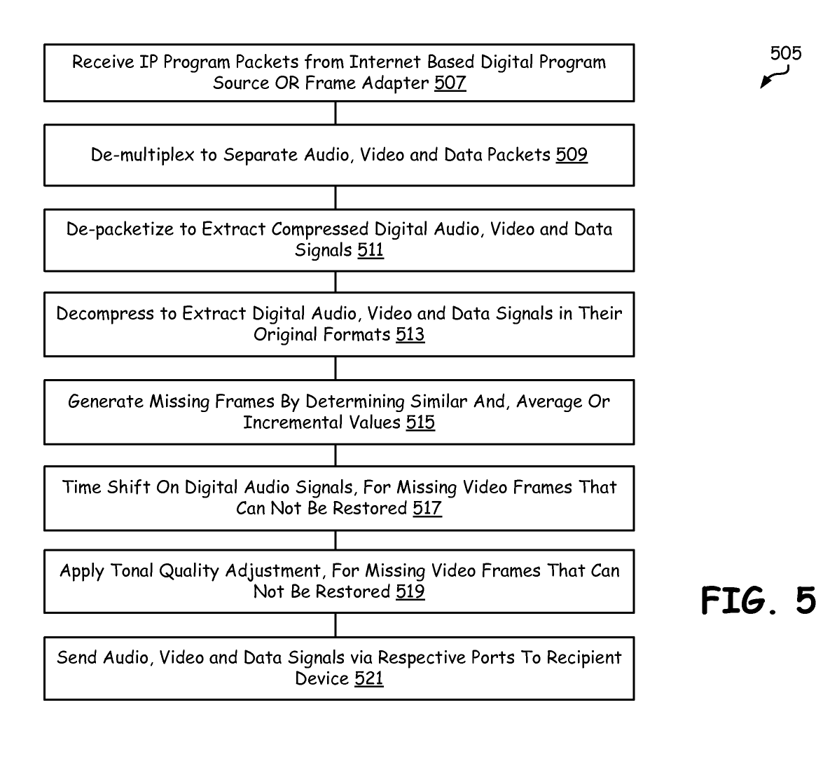

FIG. 5 is a flow diagram illustrating operation of a set top box containing a missing frame generation module and time shifting/tone adaptation module constructed and operating according to one or more embodiments of the present invention. The operations 505 begin at block 507, when the set top box receives IP program packets from an Internet based digital program source or a frame adapter. The Internet based digital program source may be any of the Internet Service Provider's (ISP's) equipments or may process and re-route programs originated by other program sources.

At a next block 509, the set top box de-multiplexes incoming IP program packets to separate audio, video and data packets. Then, at a next block 511, the set top box de-packetizes the separated audio, video and data packets to remove internet protocol information and extracts compressed digital audio, video and data contents. Then, at a next block 513, the set top box decompresses the compressed digital audio, video and data contents to extract digital audio, video and data program signals.

At a next block 515, the set top box begins to generate missing frames by first identifying one or more missing sequential video frames. If there is only one missing video frame, then, the set top box identifies one preceding and succeeding video frames, of the missing video frame, and computes pixel and color magnitudes, in their respective pixel and color positions, of both the preceding and succeeding video frames. If there are few missing sequential video frames, then the set top box identifies few preceding and succeeding sequential video frames, of the few missing sequential video frames and computes pixel and color magnitudes, in their respective pixel and color positions, of each of the few preceding and succeeding sequential video frames. The term ‘few’ may be any number of video frames that at lease one, and is suitably determined based upon the number of missing sequential video frames.

Then, the set top box identifies similarities in the magnitudes that fall within a threshold, in their respective pixel and color positions, between the preceding and succeeding video frames, and generates similar pixels and colors of the missing video frame, in case of the single missing video frame. In case of more than one missing sequential video frames, the set top box identifies similarities in the magnitudes that fall within the threshold, in their respective pixel and color positions, between the few preceding and succeeding sequential video frames, and generates similar pixels and colors of the few missing sequential video frames. These similar pixels and colors in their respective positions are common for all of the few missing sequential video frames.

Then, the set top box computes average values for the missing video frame, in their respective pixel and color positions, when the magnitudes fall beyond the threshold, from the preceding and succeeding video frames and thus generates difference pixels and colors of the missing video frame, in case of only one missing video frame. Otherwise, the set top box computes incremental magnitudes for each of the few missing sequential video frames, in their respective pixel and color positions, when the magnitudes fall beyond the threshold, from the few preceding and succeeding sequential video frames and thus generates difference pixels and colors of the few missing sequential video frames. Once, similar and difference pixels and colors are generated, the set top box combines these to generate either the missing video frame or few missing sequential video frames.

At a next block 517, the set top box time shifts and applies tone adaptation on digital audio program signals. This is done by initially eliminating digital audio program signals that correspond to the missing video frames that cannot be restored, reassembling the rest of the digital audio program signals, and re-synchronizing the remaining digital audio program signals with that of digital video program signals.

Once the time shifting operation is completed, at a next block 519, the set top box gradually shifts frequency upwards and then downwards in such a way as to not have any discernable unwanted effects in audio reproductions. The gradual upward frequency shift is performed during a period of few frames, starting at few frames before first of the missing video frames that cannot be restored and ending at the first of the missing video frames that cannot be restored. Similarly, the gradual downward frequency shift is performed for a time period starting at last of the missing video frames that cannot be restored and ending at few frames after the last of the missing video frames that cannot be restored. The gradual frequency shift itself consists of shifting entire frequency set in upward or downward directions, during the above mentioned periods. Then, at a final block 521, the set top box sends the audio, video and data signals to the recipient devices.

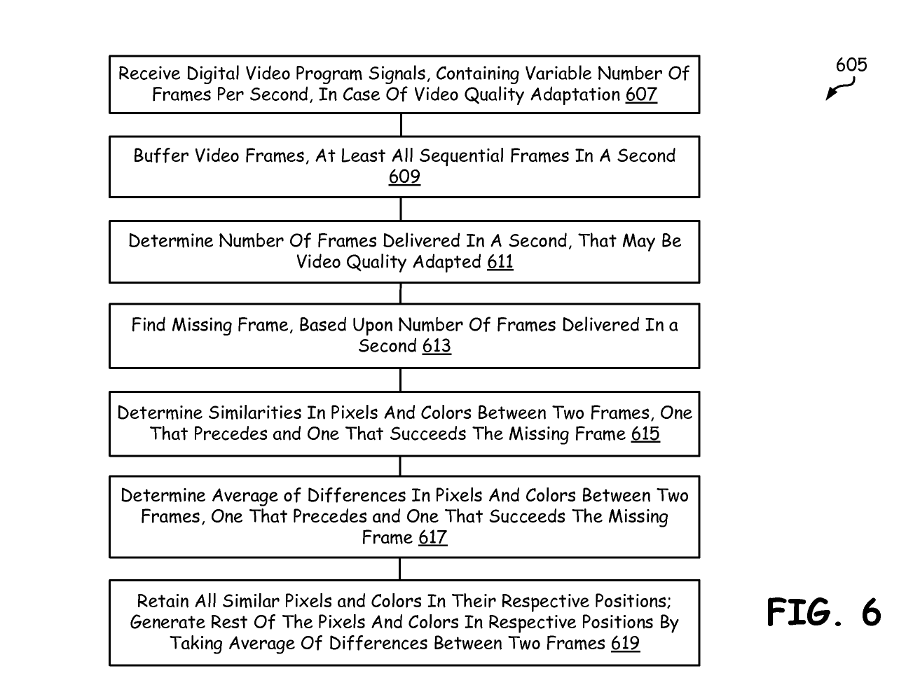

FIG. 6 is a flow diagram illustrating operation of a missing frame generation module during restoration of a lost video frame. The operations 605 of FIG. 6 begins at block 607, when the missing frame generation module receives digital video program signals, containing variable number of video frames per second, in case of video quality adaptation. At a next block 609, the missing frame generation module temporarily stores these digital video program signals that contain a plurality of sequential video frame information in a buffer. The buffer may store at least one second's sequential video frames, to be able to determine missing sequential video frames. That is, the missing frame generation module continuously buffers these sequential video frames in a queue fashion, in the buffer, and then releases back for further processing, when no missing video frames are found.

Then, at a next block 611, the missing frame generation module determines number of frames delivered in a second that may be video quality adapted. At a next block 613, the missing frame generation module continuously searches for any missing video frame in the buffer and identifies a missing video frame among the buffered video frames. Then, the missing frame generation module identifies one preceding and succeeding video frames, of the missing video frame and computes pixel and color magnitudes, in their respective pixel and color positions, of both the preceding and succeeding video frames.

Then, at a next block 615, the missing frame generation module determines similarities in the magnitudes that fall within a threshold, in their respective pixel and color positions, between the preceding and succeeding video frames, and generates similar pixels and colors of the missing video frame. Then, at a next block 617, the missing frame generation module computes average values for the missing video frame, in their respective pixel and color positions, when the magnitudes fall beyond the threshold, from the preceding and succeeding video frames and thus generates difference pixels and colors of the missing video frame.

At a final block 619, the missing frame generation module, after identifying or computing similar and difference pixels and colors for the missing video frame, restores the missing video frame by combining the similar pixels and colors of the missing video frame, and difference pixels and colors of the missing video frame, in their respective pixel and color positions.

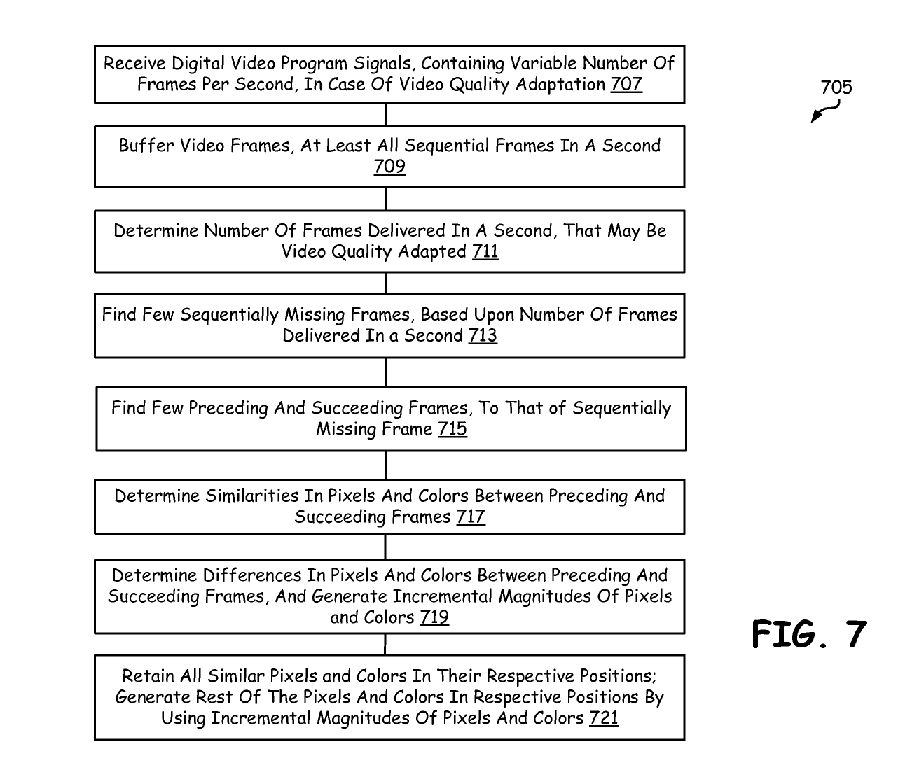

FIG. 7 is a flow diagram illustrating operation of a missing frame generation module of during restoration of sequential lost video frames. The operations 705 of FIG. 7 begin at block 707 when the missing frame generation module receives digital video program signals, containing variable number of video frames per second, in case of video quality adaptation. At a next block 709, the missing frame generation module temporarily stores these digital video program signals that contain a plurality of sequential video frame information in a buffer, for at least one second.

Then, at a next block 711, the missing frame generation module determines number of frames delivered in a second that may be video quality adapted. At a next block 713, the missing frame generation module continuously searches for more than one missing sequential video frames in the buffer and identifies few missing sequential video frames among the buffered video frames.

Then, at a next block 715, the missing frame generation module identifies few preceding and succeeding sequential video frames, of the few missing sequential video frames and computes pixel and color magnitudes, in their respective pixel and color positions, of all of the preceding and succeeding sequential video frames. Then, at a next block 717, the missing frame generation module identifies similarities in the magnitudes that fall within a threshold, in their respective pixel and color positions, between the few preceding and succeeding sequential video frames, and generates similar pixels and colors of the few missing sequential video frames. These similar pixels and colors in their respective positions are common for all of the few missing sequential video frames.

Then, at a next block 719, the missing frame generation module computes incremental magnitudes for each of the few missing sequential video frames, in their respective pixel and color positions, when the magnitudes fall beyond the threshold, from the few preceding and succeeding sequential video frames and thus generates difference pixels and colors of the few missing sequential video frames. At a final block 721, the missing frame generation module, after generating similar and difference pixels and colors for each of the few missing sequential video frames, combines them to generate each of the few missing sequential video frames.

The terms “circuit” and “circuitry” as used herein may refer to an independent circuit or to a portion of a multifunctional circuit that performs multiple underlying functions. For example, depending on the embodiment, processing circuitry may be implemented as a single chip processor or as a plurality of processing chips. Likewise, a first circuit and a second circuit may be combined in one embodiment into a single circuit or, in another embodiment, operate independently perhaps in separate chips. The term “chip”, as used herein, refers to an integrated circuit. Circuits and circuitry may comprise general or specific purpose hardware, or may comprise such hardware and associated software such as firmware or object code.

As one of ordinary skill in the art will appreciate, the terms “operably coupled” and “communicatively coupled,” as may be used herein, include direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled” and “communicatively coupled.”

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

1. A digital electronic component comprising:
a missing frame generation module that receives video programs via a communication link and that operates upon the video programs to restore a missing video frame that is lost or corrupted during transmission;
a time shifter and tone adapter;
the digital electronic component buffers received video frames in a buffer memory;
the digital electronic component identifies the missing video frame, a first video frame that precedes the missing video frame, and a second video frame that succeeds the missing video frame;
the digital electronic component generates a portion of the missing video frame by retaining similar pixels and colors from the first and second video frames;
the digital electronic component produces remaining pixels and colors of the missing video frame by taking an average between the first and second video frames;
the time shifter and tone adapter resynchronizes, and gradually shifts a frequency of the digital audio program signals; and
the digital electronic component delivers the resultant audio and video program signals to a recipient device via a communication link.

2. The digital electronic component 1, wherein the digital electronic component buffers received video frames by buffering video frames for at least one second duration or a duration of a frame set.

3. The digital electronic component 1, wherein the digital electronic component identifies the missing video frame by identifying number of video frames in a frame set and then identifying a video frame that is not generated during decoding and decompression.

4. The digital electronic component 1, wherein the digital electronic component identifies the missing video frame by identifying a number of frames in a second during video quality adaptation and then identifying a frame that is not generated during decoding and decompression.

5. The digital electronic component 1, wherein by retaining similar pixels and colors from the first and second video frames comprising comparing respective pixels locations and colors of the first and second video frames.

6. The digital electronic component 5, wherein comparing the first and second video frames, in their respective pixel and color positions includes identifying magnitudes of pixels and colors, in their respective pixel and color positions, of the first and second video frames and retaining pixels and colors that match in magnitudes within a threshold.

7. The digital electronic component 6, wherein the threshold is determined by an inability to distinguish the differences between any two video frames that fall within the threshold, in all of respective color and pixel positions.

8. The digital electronic component 1, wherein the digital electronic component produces the rest of the pixels and colors of the missing video frame by taking an average of respective pixels and colors between the first and second video frames.

9. The digital electronic component 8, wherein comparing the first and second vide frames includes identifying magnitudes of pixels and colors in their respective pixel and color positions.

10. The digital electronic component 8, wherein the digital electronic component produces the rest of the pixels and colors of the missing video frame by generating average magnitudes of pixels and colors of the first and second video frames when differences in pixel content does not exceed a comparison threshold.

11. The digital electronic component 1, wherein the time shifter and tone adapter resynchronizes, and gradually shifts frequency of, digital audio program signals to compensate for the missing frames that cannot be restored.

12. A digital electronic comprising:
a missing frame generation module receives video programs via a communication link and that restores a few missing sequential video frames that are lost or corrupted during transmission;
a time shifter and tone adapter;
the digital electronic component buffers received video frames in a buffer memory;
the digital electronic component identifies the few missing sequential video frames, a first set video frames that precedes the few missing sequential video frames, and a second set of video frames that succeeds the few missing sequential video frames;
the digital electronic component generates a portion of the few missing sequential video frames by retaining similar pixels and colors from the first and second set of video frames;
the digital electronic component produces a remainder of pixels and colors of the few missing sequential video frames by taking incremental magnitudes between the first and second set of video frames;
the time shifter and tone adapter resynchronizes and gradually shifts frequency of the digital audio program signals; and
the digital electronic component delivers the resultant audio and video program signals to a recipient device via a communication link.

13. The digital electronic component 12, wherein retaining similar pixels and colors from the first and second set of video frames includes comparing all of the pixels of the first and second set of video frames in their respective positions.

14. The digital electronic component 13, wherein comparing all of the first and second set of video frames in their respective positions includes identifying magnitudes of pixels and pixel colors of the first and second set of video frames and retaining pixels and colors that match in magnitude within a threshold.

15. The digital electronic component 12, wherein producing a remainder of pixels and colors of the few missing sequential video frames by taking incremental magnitudes between the first and second set of video frames includes considering incremental magnitudes between pixels of the first and second set of video frames.

16. The digital electronic component 15, wherein the digital electronic device is operable to compare magnitudes of pixels and colors of all of the first and second set of video frames and compute magnitudes incrementally from the respective pixels and colors that differ in magnitudes beyond the threshold.

17. The digital electronic component 12, wherein the digital electronic device produces all of the pixels and colors of the few missing sequential video frames by taking incremental magnitudes from the first set of video frames alone when there are differences between any two video frames beyond an average difference threshold in the second set of video frames.

18. The digital electronic component 12, wherein the digital electronic device produces all of the pixels and colors of the few missing sequential video frames by taking incremental magnitudes from the second set of video frames alone when there are differences between any two video frames beyond an average difference threshold in the first set of video frames.

19. The digital electronic component 12, wherein the time shifter and tone adapter resynchronizes, and gradually shifts frequency of digital audio program signals to compensate for the missing frames that cannot be restored.

20. A method performed by a digital video component comprising:
identifying at least one missing sequential video frames;
identifying few preceding and succeeding sequential video frames of the few missing sequential video frames;
computing pixel and color magnitudes, in their respective pixel and color positions of each of the few preceding and succeeding sequential video frames;
identifying similarities in the magnitudes that fall within a threshold in their respective pixel and color positions between the few preceding and succeeding sequential video frames to generate similar pixels and colors of the few missing sequential video frames;
computing incremental magnitudes for each of the few missing sequential video frames in their respective pixel and color positions when the magnitudes fall beyond the threshold from the few preceding and succeeding sequential video frames to generate difference pixels and colors of the few missing sequential video frames; and
generating the few missing sequential video frames by combining the similar pixels and colors of the few missing sequential video frames and difference pixels and colors of the few missing sequential video frames, in their respective video frames, and pixel and color positions.
